(19) United States
(12) Patent Application Publication
(10) Pub. No.: US 2007/0091408 A1
(43) Pub. Date: Apr. 26, 2007

(54) Color display apparatus and recorded medium for controlling color images

(75) Inventor: In-Jae Yeo, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon-si (KR)

(21) Appl. No.: 11/582,940

(22) Filed: Oct. 17, 2006

(30) Foreign Application Priority Data
Oct. 2, 2006 (KR) 10-2006-0097433
Oct. 19, 2005 (KR) 10-2005-0098683

(51) Int. Cl. G02B 26/08

(52) U.S. Cl. 359/216

(57) ABSTRACT

Disclosed is a color display apparatus including: A) an N (N is a natural number greater than 2) number of light sources each emitting a different color light in accordance with light source control signals controlling on/off states thereof; B) a one dimensional optical modulator element generating diffracted light by modulating the color light emitted from the light sources in accordance with optical modulator control signals; C) a scanner scanning and projecting the diffracted light from the one dimensional optical modulator element onto a display surface in accordance with scanner control signals; and D) an image control circuit receiving image signals, and transferring: the light source control signal, which turns on the N number of light sources each once, and turns on the light source having the weakest optical power thereamong once more, the optical modulator control signal, which contains light intensity information extracted from the image signal and corresponding to the turned on light source, and the scanner control signal controlling operation of the scanner which is based on the optical modulator control signal, to the light source, the one dimensional optical modulator, and the scanner, respectively so as to control the same.

### BACKGROUND

1. Technical Field

The present invention relates to a color display apparatus, in particular, to a color display apparatus generating a two dimensional image by scanning one dimensional image signals from a single optical modulator element to a screen by using a scanner.

2. Description of the Related Art

As display technologies have advanced, the demand on large screen display devices has grown. The majority of current large screen display devices (mainly projectors) are using liquid crystals as a light-switch. Such a liquid crystal projector has been popular due to the fact that it is smaller and cheaper, and has a simpler optical system than a CRT projector. However, in the liquid crystal projector, large amount of light is lost since the light is projected into a screen by passing through a liquid crystal panel. A micro-machine such as an optical modulator element using optical reflection is employed to reduce such light loss, by which brighter images are obtained.

The micro-machine refers to a miniature machine indiscernible with naked eyes. It can also be called a micro electro mechanical system (MEMS), and mainly fabricated by semiconductor manufacturing technology. These micro-machines are applied in information devices such as magnetic and optical heads by using micro-optics and limitation elements, and also applied in bio-medical field and semi conductor manufacturing process by using various micro-fluidics. The micro-machines can be divided based on their function into a micro-sensor, a micro-actuator and a miniature machine.

The MEMS can also be applied in optics. Using MEMS technology, optical components smaller than lmm can be fabricated, by which micro optical systems are implemented.

Micro optical components belonging to the micro-miniature optical system such as an optical modulator element, a micro-lens, and the like are applied in telecommunication devices, display devices and recording devices, due to such advantages as quick response time, low level of loss, and convenience in layering and digitalizing.

Panel type color display apparatuses (a projection apparatus, for example) employing the one dimensional optical modulator element in which the MEMS element is applied use red, green, and blue light, which are three primary colors, in order to display color images.

In such display apparatuses, commonly used light sources are employed to emit the red, green, and blue color light. However, there are frequent occasions where the ideal optical power ratio per color, which is required to generate a certain color image, is different from the optical power ratio per color of the available light sources, and thus color images having desired brightness cannot be realized due to the ratio difference.

### SUMMARY

One aspect of the present invention provides a color display apparatus including: A) an N (N is a natural number greater than 2) number of light sources each emitting a different color light in accordance with light source control signals controlling on/off states thereof; B) a one dimensional optical modulator element generating diffracted light by modulating the color light emitted from the light sources in accordance with optical modulator control signals; C) a scanner scanning and projecting the diffracted light from the one dimensional optical modulator element onto a display surface in accordance with scanner control signals; and D) an image control circuit receiving image signals, and transferring: the light source control signal, which turns on the N number of light sources each once, and turns on the light source having the weakest optical power thereamong once more, the optical modulator control signal, which contains light intensity information extracted from the image signal and corresponding to the turned on light source, and the scanner control signal controlling operation of the scanner which is based on the optical modulator control signal, to the light source, the one dimensional optical modulator element, and the scanner, respectively so as to control the same.

Here, the N number of light sources are composed of red, green, and blue light sources.

Also, the scanner is a rotating galvano scanner performing bi-directional scanning during one rotation of the scanner, and scanning the diffracted light corresponding to one of the N number of light sources per half rotation of the scanner, so that one frame of full color image is projected onto the screen by (N+1)/2 rotations of the galvano scanner.

Here, the galvano scanner rotates (N+1)/2 times within 1/(the field frequency according to a television broadcasting system) [sec].

Furthermore, the scanner is a rotating polygon mirror scanner having the shape of a polygonal prism, and performing single directional scanning, and the polygon mirror scanner scans the diffracted light corresponding to one of the N number of light sources per 1/(the number of sides of the polygonal prism) rotation of the scanner, so that one frame of full color image is projected onto the screen by (N+1)/(the number of sides of the polygonal prism) rotations of the polygon mirror scanner.

Here, the polygon mirror scanner rotates (N+1)/(the number of sides of the polygonal prism) times within 1/(the field frequency according to a television broadcasting system) [sec].

Another aspect of the present invention provides a recorded medium which tangibly embodies a program having instruction codes on image controlling executable in a color display apparatus including light sources, a one dimensional optical modulator element, and a scanner, and is readable by the color display apparatus, wherein the image controlling includes: (a) turning on one of an N (N is a natural number greater than 2) number of light sources each emitting a different color light; (b) transferring light intensity information on a color corresponding to the turned on light source to the one dimensional optical modulator element; (c) controlling the scanner so that diffracted light generated by the one dimensional optical modulator element are scanned and projected onto a display surface; and (d) repeating the steps (a) through (c) until the light source having the weakest power among the N number of light sources is turned on twice, and the rest of the light sources are turned on each once.

Here, the steps (a) through (c) are performed within 1/{(the field frequency according a television broadcasting system)×(N+1)} [sec].

Another aspect of the present invention provides a recorded medium which tangibly embodies a program having instruction codes on image controlling executable in a color display apparatus including light sources, a one dimensional optical modulator element, and a scanner, and is readable by the color display apparatus, wherein the image controlling includes: (a) turning on one of an N (N is a natural number greater than 2) number of light sources each emitting a different color light; (b) transferring light intensity information on a color corresponding to the turned on light source to the one dimensional optical modulator element; (c) controlling the scanner so that diffracted light generated by the one dimensional optical modulator element are scanned and projected onto a display surface; and (d) repeating the step (c) twice consecutively while the light source having the weakest power among the N number of light sources is turned on, and repeating the steps (a) through (c) until the rest of the light sources are turned on each once.

Here, the steps (a) through (c) are performed within 1/{(the field frequency according to a television broadcasting system)×(N+1)} [sec].

Additional aspects and advantages of the present general inventive concept will be set forth in part in the description which follows, and in part will be obvious from the description, or may be learned by practice of the general inventive concept.

### BRIEF DESCRIPTION OF THE DRAWINGS

These and other features, aspects, and advantages of the present invention will become better understood with regard to the following description, appended claims, and accompanying drawings where:

FIG. 1 is a schematic view of a color display apparatus using a one dimensional optical modulator element according to an embodiment of the present invention;

FIG. 2 illustrates the configuration of a GLV (grating light valve) device, one of the optical modulators manufactured by the Silicon Light Machine Co., Ltd.;

FIG. 3 shows a principle of optical modulation by which incident light are modulated in the GLV device of the FIG. 2;

FIG. 4A is a perspective view of a diffraction type optical modulator element using piezoelectric materials and applicable to an embodiment of the present invention;

FIG. 4B is a perspective view of another diffraction type optical modulators element using piezoelectric elements and applicable to an embodiment of the present invention;

FIG. 5A is a plan view of a diffraction type optical modulator array applicable to an embodiment of the present invention;

FIG. 5B explains a principle of optical modulation of a diffraction type optical modulator applicable to an embodiment of the present invention;

FIG. 6 illustrates the configuration of one frame projected onto a screen according to an embodiment of the present invention;

FIGS. 7(a) through 7(e) illustrate a method for displaying color image by using a galvano scanner according to an embodiment of the present invention;

FIG. 8 illustrates a method for displaying color images of consecutive frames by using the galvano scanner of FIG. 7 according to an embodiment of the present invention;

FIG. 9 illustrates a method for displaying color images of consecutive frames by using a polygon mirror scanner according to an embodiment of the present invention;

FIGS. 10A and 10B illustrate light source control signals, optical modulator control signals, and scanner control signals transferred with passage of time; and

FIGS. 11(a) through 11(c) are tables for comparing the brightness between a 4-time scan and a 3-time scan.

### DETAILED DESCRIPTION

Hereinafter, embodiments of the invention will be described in more detail with reference to the accompanying drawings. In the description with reference to the accompanying drawings, those components are rendered the same reference number that are the same or are in correspondence regardless of the figure number, and redundant explanations are omitted.

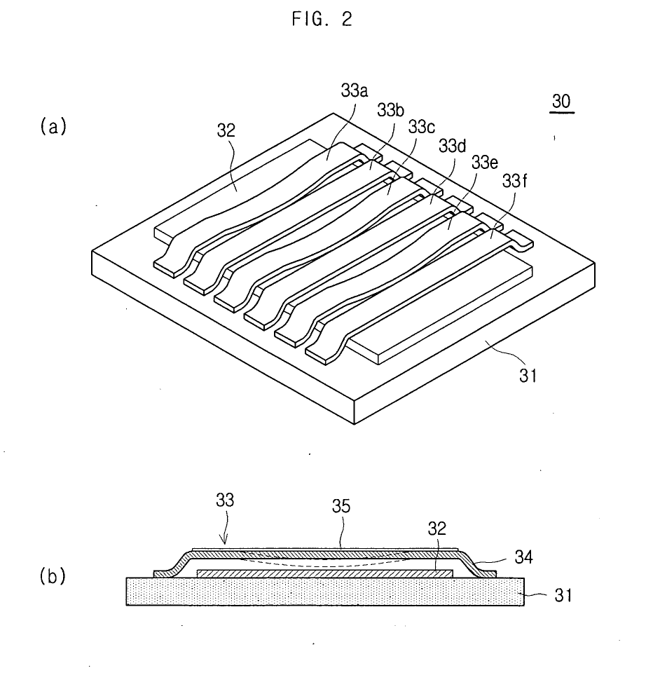

An optical modulator applicable to the present invention will first be described with reference to FIGS. 2 to 5, before discussing embodiments of the present invention.

The optical modulator can be divided mainly into a direct type, which directly controls the on/off state of light, and an indirect type, which uses reflection and diffraction. The indirect type may be further divided into an electrostatic type and a piezoelectric type. Optical modulators are applicable to the embodiments of the present invention regardless of the operation type.

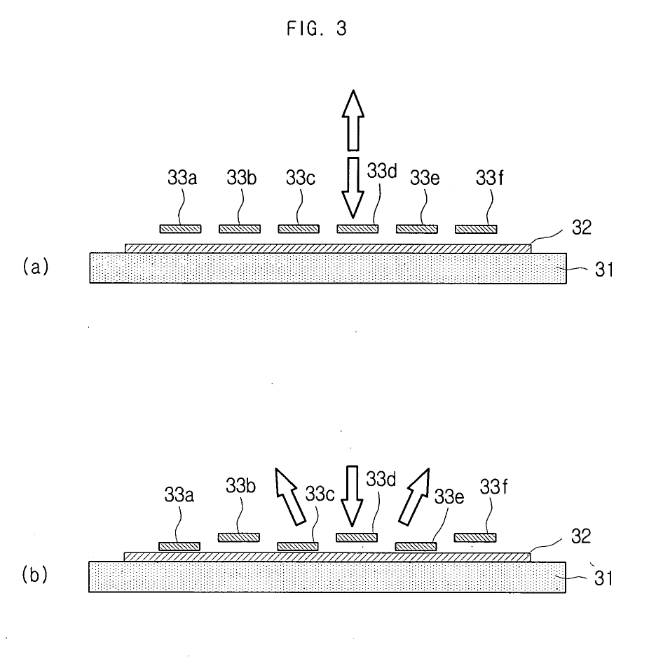

FIG. 2 shows the configuration of a GLV (grating light valve) device, one of the light modulators manufactured by the Silicon Light Machine Co., Ltd, and FIG. 3 shows a principle of optical modulation by which an incident light is modulated in the GLV device 30 of the FIG. 2.

As shown in FIG. 2, the GLV device 30 comprises an insulation substrate 31 such as a glass substrate, a substrate side electrode 32 formed on the insulation substrate 31, and a plurality of beams 33a to 33f, hereinafter abbreviated as 33 (here in this embodiment, the number of the beams is 6), having a bridge-shape and disposed across the substrate side electrode 32 in parallel.

Each beam 33 consists of a bridge part 34 and a drive side electrode 35 formed of aluminum (Al) film and mounted on the bridge part 34 to function also as a reflective film, so that both ends of the beam are supported to form a so called bridge type.

The beam 33 gets bent due to attractive or repulsive forces between itself and the substrate side electrode 32 according to electric potential between the substrate side electrode 32 and the drive side electrode 35. As drawn in solid and dotted lines in FIG. 2(b), the beam 33 bends toward the substrate side electrode 32 or returns to a parallel mode.

The plurality of beams 33 are alternately changed to the parallel or concave modes. When power is not supplied, the beams 33 remain in the parallel mode as shown in FIG. 3(a). However, when a minute power is supplied to the odd-numbered beams 33a, 33c and 33e, the odd-numbered beams 33a, 33c and 33e are converted to a concave mode, while the even-numbered beams 33b, 33d and 33f remain in the parallel mode. In such case, incident light is diffracted (interfered) due to the pathlength difference between a first reflective light reflected by the odd-numbered beams 33a, 33c and 33e and a second reflective light reflected by the even-numbered beams 33b, 33d and 33f, so that the intensity of the light is modulated. By using the above, the gray scale of screen pixels, namely light intensity, is expressed. It is assumed that the plurality of beams 33 (the number of them is six in this embodiment) express a single light intensity, and constitute a single micro-mirror.

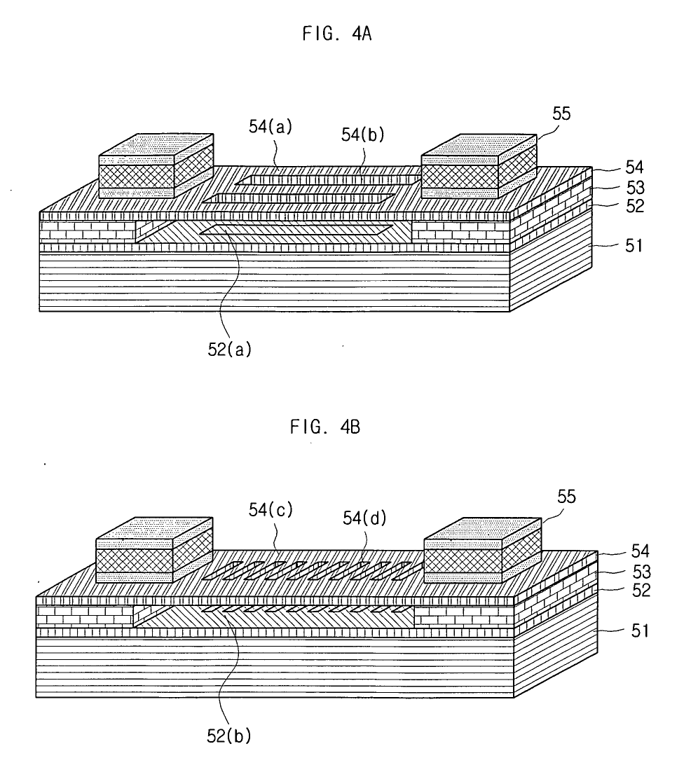

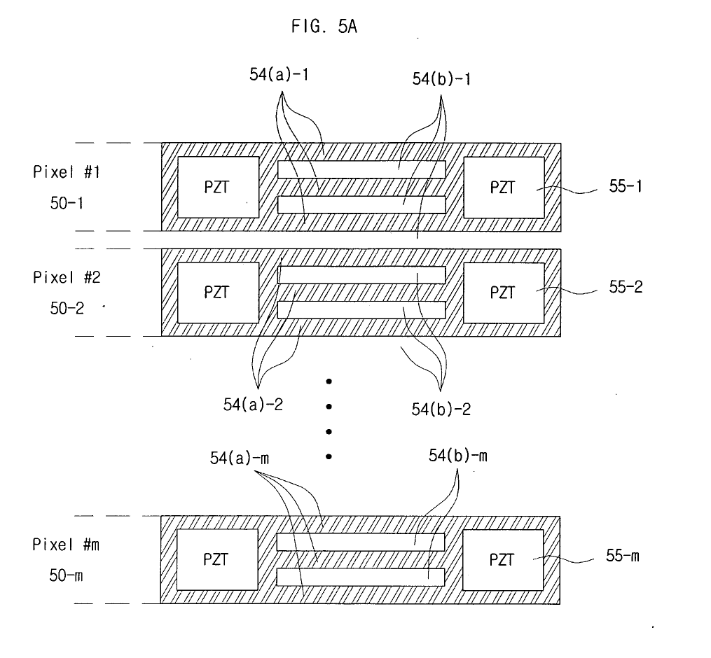

FIG. 4A is a perspective view of a diffraction type optical modulator element using piezoelectric material, one of indirect type optical modulators applicable to the embodiments of the present invention, and FIG. 4B is a perspective view of another diffraction type optical modulator element using piezoelectric material applicable to the embodiments of the present invention. In FIGS. 4A and 4B is illustrated an optical modulator comprising a substrate 51, an insulation layer 52, a sacrificial layer 53, a ribbon structure 54 and piezoelectric elements 55.

The substrate 51 is a commonly used semiconductor substrate, and the insulation layer 52 is deposited as an etch stop layer. The insulation layer 52 is formed of a material with a high selectivity to the etchant (the etchant is an etchant gas or an etchant solution) that etches the material used as the sacrificial layer. Here, reflective layers 52(a) and 52(b) may be formed on the insulation layer 52 to reflect incident light.

The sacrificial layer 53 upholds the ribbon structure 54 at both ends of the ribbon structure 54 to leave a gap between the ribbon structure 54 and the insulation layer 52, and forms a space in the center portion.

As described above, the ribbon structure 54 modulates signals optically by creating diffraction and interference in the incident light. The ribbon structure 54 may be composed of a plurality of ribbon shapes according to the electrostatic type, and may have a plurality of open holes in the center part of the ribbons according to the piezoelectric type. The piezoelectric elements 55 control the ribbon structure 54 to move vertically according to the degree of up/down or left/right contraction or expansion generated by the voltage difference between the upper and lower electrodes. Here, the reflective layers 52(a) and 52(b) are formed in correspondence with holes 54(b) and 54(d) formed on the ribbon structure 54.

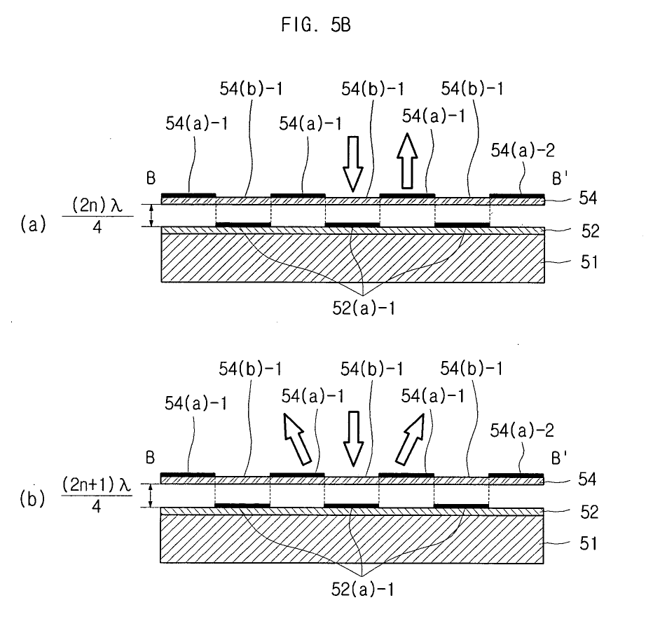

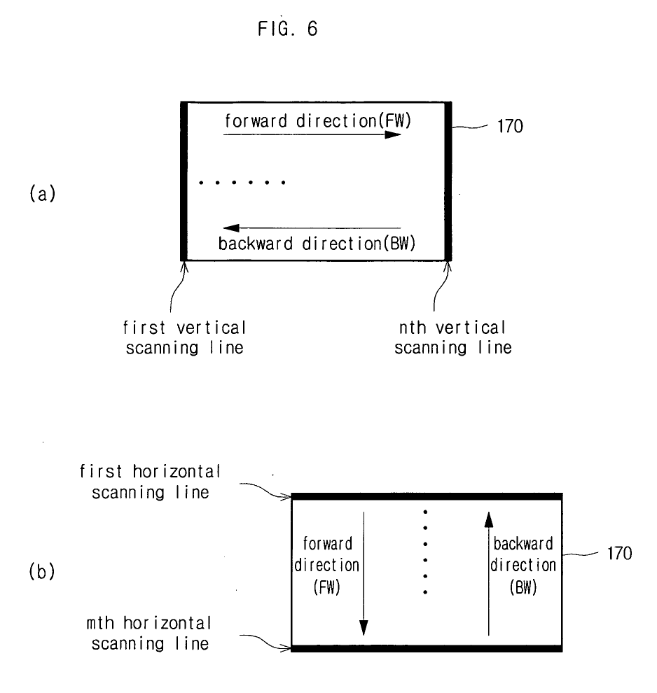

FIG. 5A is a plan view of a diffraction type optical modulator array applicable to an embodiment of the present invention, and FIG. 5B explains a principle of optical modulation of a diffraction type optical modulator applicable to an embodiment of the present invention. The descriptions below will focus on the type of optical modulator illustrated in FIG. 4A.

As shown in FIG. 5A, the optical modulator has an m number of micro-mirrors 50-1, 50-2, . . . , and 50-m, respectively responsible for pixel #1, pix #2 . . . , and pixel #m. The optical modulator deals with image information with respect to one-dimensional images of vertical or horizontal scanning lines. (Here, it is assumed that a vertical or horizontal scanning line consists of an m number of pixels), and each micro-mirror 50-1, 50-2, . . . , 50-m deals with each of the m pixels constituting the vertical or horizontal scanning lines.

Accordingly, the light beam reflected and diffracted by each micro-mirror is later projected by an optical scanning device on a screen as a two-dimensional image. For instance, in the case of VGA 640*480 resolution, 480 vertical pixels are modulated 640 times on one surface of the optical scanning device (not shown in the accompanying drawings) so as to generate one frame per surface of the optical scanning device.

Below here, the principle of optical modulation will be set forth with an emphasis on the pixel #1, however, the following description can surely be applied to the other pixels in the same way.

In the present embodiment, it is assumed that two holes 54(b)-1 are formed in the ribbon structure 54. Due to the two holes 54(b)-1, there are three upper reflective layers 54(a)-1 formed on an upper part of the ribbon structure 54. On the insulation layer 52 are formed two lower reflective layers in correspondence with the two holes 54(b)-1. Besides, another lower reflective layer is formed on the insulation layer 52 in correspondence with a gap between the pixel #1 and the pixel #2. Consequently, the number of the upper reflective layers 54(a)-1 per pixel is the same as the number of the lower reflective layers, and the brightness of the modulated light can be controlled by using the modulated light (0th order diffracted light or ±1st order diffracted light).

FIG. 5B, a cross-sectional view along the line BB′ of FIG. 5A, explains a principle of optical modulation of a diffraction type optical modulator.

For example, in the case where the wavelength of the light equals λ, when a first voltage is applied to the piezoelectric elements 55 so that the gap between the upper reflective layer 54(a), 54(c) formed on the ribbon structure 54 and the insulation layer 52, where the lower reflective layer 52(a), 52(b) is formed, becomes equal to (2n) λ/4 (wherein n is a natural number). Accordingly, in the case of a zeroth (0th) order diffracted light (reflected light) beam, the overall path difference between the light reflected from the upper reflective layer 54(a), 54(c) formed on the ribbon structure 54 and the light reflected from the insulation layer 52 is equal to nλ, so that the modulated light has a maximum brightness due to a constructive interference. On the other hand, in the case of +1st and −1st order diffracted light, the brightness is at its minimum level due to a destructive interference.

When a second voltage is applied to the piezoelectric elements 55 so that the gap between the upper reflective layer 54(a), 54(c) formed on the ribbon structure 54 and the insulation layer 52, where the lower reflective layer 52(a), 52(b) is formed, becomes equal to (2n+1)λ/4 (wherein n is a natural number). Accordingly, in the case of 0th-order diffracted light (reflected light) beam, the overall pathlength difference between the light reflected from the upper reflective layer 54(a), 54(c) formed on the ribbon structure 54 and the light reflected from the insulation layer 52 equals to (2n+1)λ/2, so that the modulated light has its minimum brightness due to a destructive interference. However, in the case of +1st and −1st order diffracted light, the brightness is at its maximum level due to a constructive interference. As a result of such interference, the optical modulator can load signals on the light beam by regulating the quantity of the reflected or diffracted light.

Although the foregoing describes the cases in which the gap between the ribbon structure 54 and the insulation layer 52 on which the lower reflective layer 52(a), 52(b) is formed is equal to (2n)λ/4 or (2n+1)λ/4, it is obvious that a variety of embodiments, having a gap with which the intensity of light is controlled by diffraction and reflection, can be applied to the present invention.

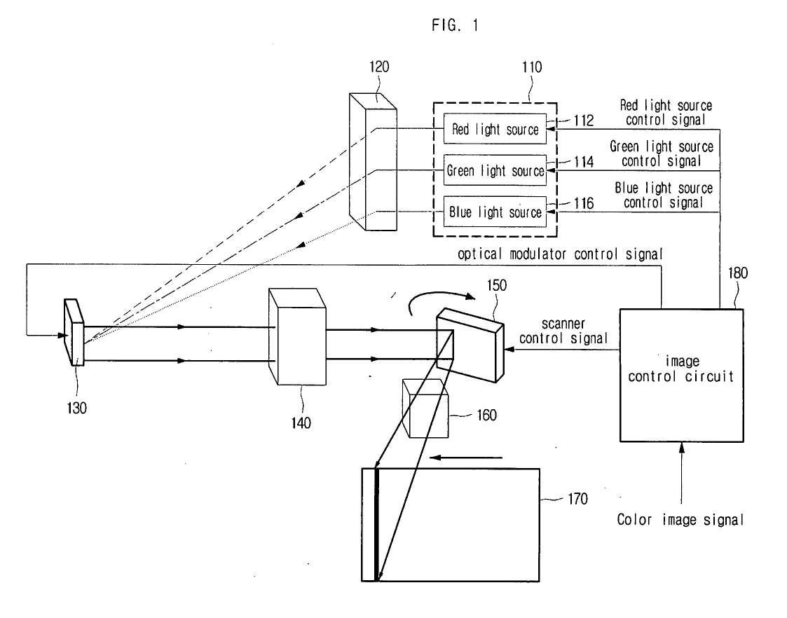

FIG. 1 is a schematic view of a color display apparatus using a one dimensional optical modulator element according to an embodiment of the present invention.

In the present invention, the color display apparatus refers to projection apparatuses. Also, the one dimensional optical modulator element generates diverse intensities of diffracted light by employing a GLV device, a MEMS structure, or the interference principle, thereby capable of loading a variety of signals on the light. The optical modulator collectively refers to a device dealing with one dimensional image pixels as described above.

While the description below concentrates on a case where scanning is performed four times by using three light sources, it is to be appreciated that the scope of the invention also includes a color display apparatus and a display method thereof using an N (where N is a natural number larger than 3) number of light sources to perform the scanning (N+1) times.

As shown in FIG. 1, the color display apparatus using the one dimensional element comprises a light source unit 110, an optical illuminating unit 120, a single panel (namely, a single one dimensional optical modulator element) 130, an optical relay unit 140, a scanner 150, a projection unit 160, a screen 170 or other type of display surface or projection medium, and a image control circuit 180. Here, details on the optical illuminating unit 120, the optical relay unit 140, and the projection unit will be omitted, because they are typical components of the projection apparatuses.

The light source unit 110 have a red light source 112, a green light source 114, and a blue light source 116 emitting red, green, and blue light, respectively. Here, it is preferable that the light source unit 110 emits three primary color light, but also can emit other color light. The three light sources of the light source unit 110 preferably are laser light sources.

Each color light emitted from the light source unit 110 is reflected at a predetermined angle to be incident on the one dimensional optical modulator element 130, and preferably, one color light is incident at a time.

As described above, the optical modulator element 130 generates diffracted light by modulating the incident light according to light intensity information on one scanning line. Here, the scanning line refers to one of horizontal or vertical lines, constituting one frame. Hereinafter, the one dimensional optical modulator 130 deals with one vertical scanning line at a time, but it shall not limit the scope of the invention.

The one dimensional optical modulator 130 preferably has as many GLV devices 200 shown in FIG. 2 or MEMS elements shown in FIG. 4 as the number of pixels constituting one vertical pixels disposed in parallel with each other to deal with one vertical scanning line. The vertical scanning lines contain a one dimensional image, which is scanned by the scanner 150 to be displayed on the screen 170 as a two dimensional image.

The optical modulator element 130 receives a color light empty of image information, and loads image information (namely, light intensity information) on corresponding color light and corresponding vertical scanning line on the color light according to an optical modulator control signal transferred from the image control circuit 180, which will be described later. The foregoing process is called an optical modulation. The one dimensional optical modulator element 130 functions as a panel representing the image information. Through this, the color light with the image information, namely, a diffracted light, is transferred to the scanner 150 via the optical relay unit 140.

The scanner 150 scans the diffracted light to the space according to a scanner control signal transferred from the image control circuit 180. The optical projection unit 160 comprises a projection lens, and projects the diffracted light scanned to the space by the scanner 150 onto the screen 170 as a color image

As described above, the diffracted light scanned to the space by the scanner 150 is a one dimensional image signal, which was modulated by the optical modulator element 130.

The scanner 150 rotates in a horizontal direction, by which the diffracted light is projected to a vertical line positioned in correspondence with image signal on the screen 170. After all the image signals corresponding to each vertical line are projected in a horizontal direction due to the rotation of the scanner 150, one frame, namely, one picture is completed. This scanner 150 may be a galvano scanner or a polygon mirror scanner.

In the foregoing description, the scanner 150 scans in a horizontal direction, and the one dimensional optical modulator element 130 modulates each vertical scanning line. However, it is obvious that the scanner 150 can also scan in a vertical direction, and accordingly, the one dimensional optical modulator element 130 can also modulate each horizontal scanning line.

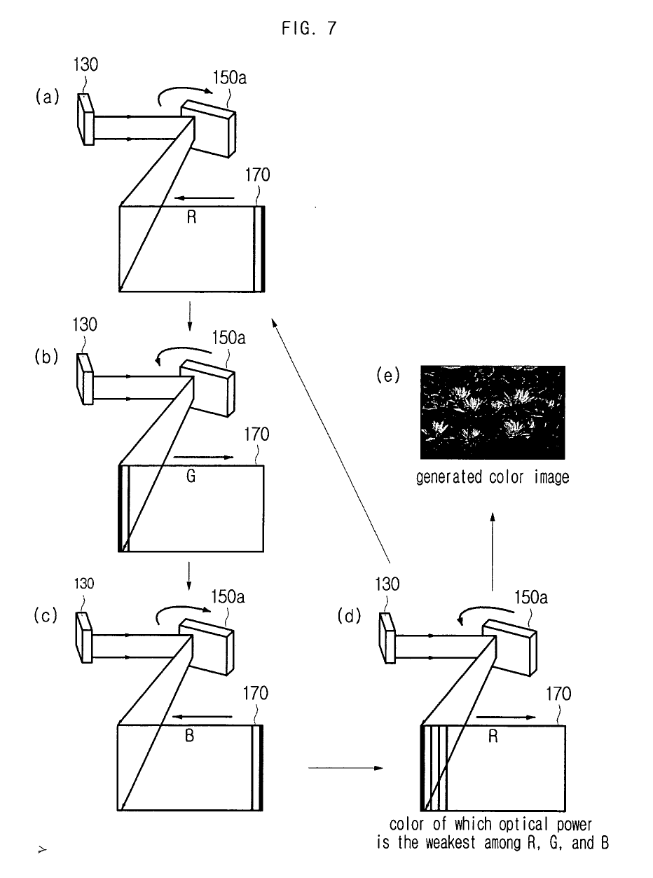

The image control circuit 180 receives image signals having image information regarding frames constituting one picture. The image information includes light intensity information regarding the red, green and blue light of pixels, the number of which is equal to (the number of vertical line pixels)×(the number of horizontal line pixels). For example, in the case that the number of vertical line pixels is m (m is a natural number), and the number of horizontal line pixels is n (n is a natural number), one frame is said to be composed of an n number of vertical lines or an m number of horizontal lines. (See FIG. 6).

The image control circuit 180 extracts the light intensity information regarding the red, green and blue light each once according to a predetermined order, and subsequently, extracts the light intensity information regarding one of the three color light once more. Otherwise, the light intensity information regarding red, green, and blue colors are stored in a buffer memory (not shown in the accompanying drawings), so that they can be extracted in a predetermined order.

Here, the color light, of which the light intensity information is again extracted, is preferably emitted from the light source having the weakest optical power among the three light sources 110. For example, in the case that the red light source has the weakest optical power, the light intensity information may be extracted four times in the order of red, green, blue, and red. Here, the extraction can be preformed in any other order as long as the color light of the weakest light source is extracted twice.

FIG. 6 shows the configuration of one frame projected onto the screen according to the present invention.

Referring to FIG. 6, when the scanner 150 scans in a horizontal direction, a direction from a first vertical line toward an nth vertical line is defined as a forward direction, and a direction from the nth toward the first is defined as a backward direction. Hereinafter, when a rotation direction in a horizontal direction of the scanner 150 in a horizontal direction is counter-clockwise direction, it is defined as a forward direction. It is surely apparent that it may be the other case.

Otherwise, when the scanner 150 scans in a vertical direction, a direction from a first horizontal line to an mth horizontal line is defined as a forward direction, and a direction from the mth to the first is defined as a backward direction.

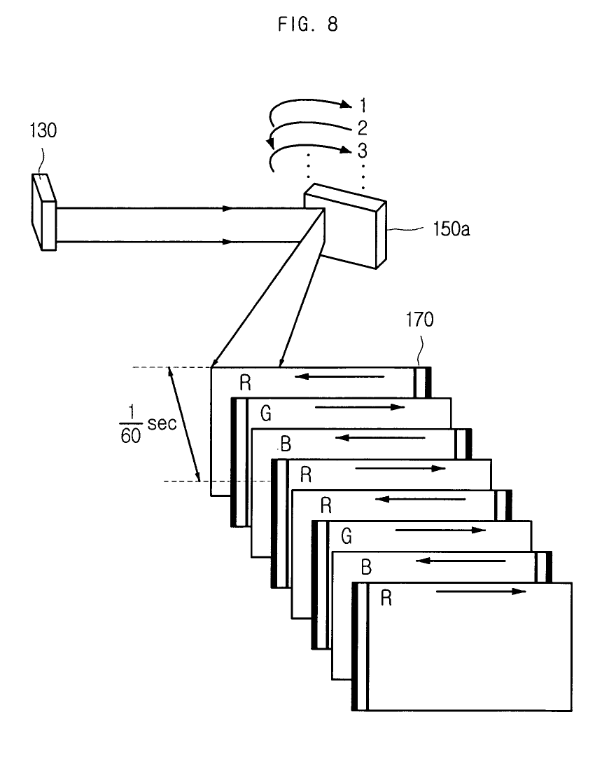

FIG. 7 shows a method for displaying color images by using a galvano scanner 150a according to an embodiment of the present invention.

Hereinafter, it is assumed that the light source control signal, the optical modulator control signal, and the scanner control signal are transferred to the light source unit 110, the optical modulator element 130, and the scanner 150, respectively, such that the scanning is performed in the order of red, green, blue, and the color corresponding to the light source having the weakest light power. The scanning surely can be performed in another order.

Furthermore, the below color image display method may be embodied as a recorded medium (hard disks, CD-ROMs, for example), which contains a program having instruction codes on image controlling executable in the color display apparatus, and is readable by the color display apparatus.

A first scanning will be described in the following.

Referring to FIG. 7(a), in the case that the light intensity information regarding the red color is first extracted, the image control circuit 180 transfers a light source control signal to the light source unit 110, such that the red light source 112 is turned on, but the green light source 114 and the blue light source 116 are turned off. Also, the image control signal 180 transfers an optical modulator control signal, comprising the light intensity information regarding the nth vertical line, to the one dimensional optical modulator 130.

At the time that a diffracted light modulated according to the optical modulator control signal is transferred from the one dimensional optical modulator 130 to the galvano scanner 150a, the image control circuit 180 transfers a scanner control signal to the galvano scanner 150a, such that the galvano scanner 150a rotates to adjust its position so that the diffracted light can be projected to a location on the screen 170 or other display surface corresponding to the nth vertical line. Here, the scanner control signal may be an angular speed control signal, according to which the scanner 150 rotates in a first direction (clockwise, in this example) at a predetermined rate, or may be a position control signal according to which the scanner 150 rotates to a predetermined position at a certain time.

Subsequently, the image control circuit 180 transfers the optical modulator control signal and the scanner control signal corresponding to each vertical scanning line to the optical modulator element 130 and the galvano scanner 150a, respectively, in the order of from the (n−1)th vertical scanning line to the first vertical scanning line.

A second scanning will be described in the following.

Referring to FIG. 7(b), after the backward directional projection with respect to the red color is completed, the light intensity information on the green color is extracted. The green color information is projected onto the screen 170 in a similar manner as the red color information.

The galvano scanner 150a rotates counter-clockwise in the second scanning, since it can rotate bidirectionally. Thus, in the case of the green color, the projection is performed in a forward direction in the order of from the first to nth vertical lines. Accordingly, when the light intensity information on the green color is extracted, the optical modulator control signal corresponding to the light intensity information with respect to the first vertical scanning line should be first transferred to the one dimensional optical modulator element 130.

The following describes a third scanning.

Referring to FIG. 7(c), after the forward projection with respect to the green color is completed, the light intensity information on the blue color is extracted, and then projected onto the screen 170 or other display surface in the same manner as in the first scanning.

The following describes a fourth scanning.

Referring to FIG. 7(d), after the backward projection with respect to the blue color is completed, the light intensity information on any of the red, green, and blue colors is extracted again.

Here, the color light, of which the light intensity information is again extracted, is preferably emitted from the light source having the weakest light power (hereinafter, abbreviated to “the weakest light source”) among the three light sources of the light source unit 110.

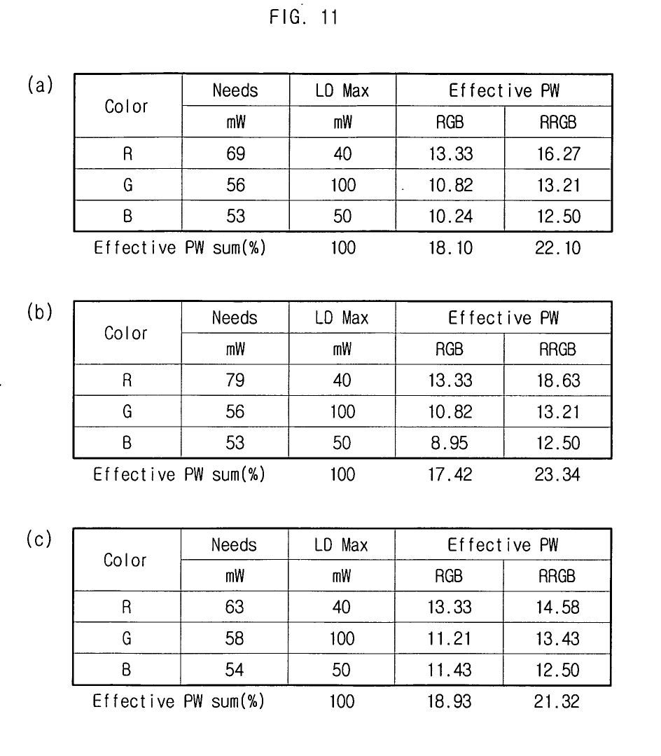

The ratio between maximum optical power and ideally required optical power of the weakest light source is smallest among those ratios of the three light sources. This will be further explained through the description regarding FIG. 11 below.

In the fourth scanning, the light intensity information on the color light emitted from the weakest light source (the red light source, in this embodiment) is projected onto the screen 170 in the same manner as in the second scanning.

As shown in FIG. 7(e), as a result of a total of 4 scans, from the first to fourth scans, a full color image picture is generated on the screen. Here, it should take less than 1/(the field frequency according to a television broadcasting system) [sec] to generate one frame with full color image.

The field frequency according to a television broadcasting system refers to a minimum frequency at which a video stream is perceived by human eyes without an image interruption. Television broadcasting systems for the color display apparatus are mainly divided into NTSC (national television system committee) system and PAL (phase alternation by line) system.

In the NTSC system, red, green and blue signals are matrix transformed to one luminance signal (Y) and two chrominance signals (I, Q), and then transmitted with a bandwidth of 6 MHz. The PAL system has improved the drawback of the NTSC in the color transmission. While the NTSC has 525 scanning lines and a 60 Hz of field frequency, PAL has 625 scanning lines and a 50 Hz of field frequency.

When the primary colors are projected to one picture within a time less than 1/(field frequency (in the case of NTSC, 60 Hz, and in the case of PAL, 50 Hz))[sec], human eyes have an illusion that a picture having a full color image is being formed simultaneously. Accordingly, in the case that red, green and blue colors are projected each once within a time less than 1/(field frequency)[sec], humans feel as if the three colors are simultaneously projected.

The present invention enhances the brightness of a full color image by scanning the weakest light source twice to perform a total of 4 scans, for which the galvano scanner 150a conducts a total of 2 rotations bi-directionally (total 4 scans).

Here, the galvano scanner 150a completes one rotation by rotating clockwise and counterclockwise each once. Consequently, the two rotations of the galvano scanner 150a preferably take less than 1/(the field frequency) [sec], and a bi-directional scan frequency of the galvano scanner 150a is preferably twice as high as the field frequency.

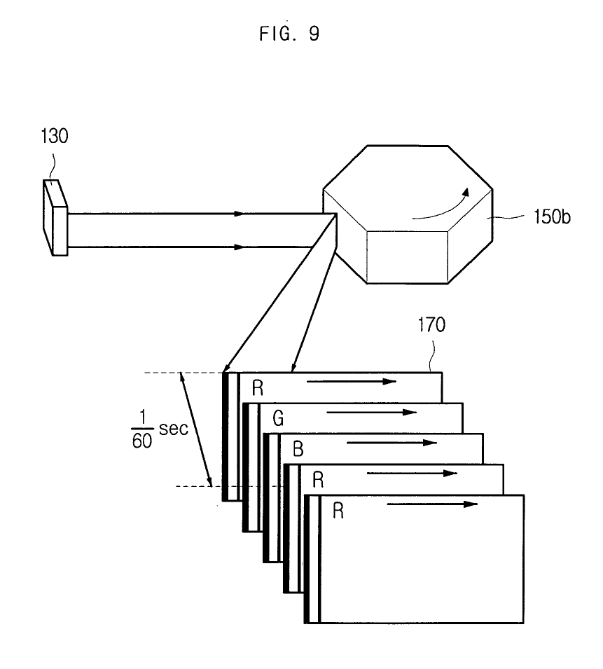

FIG. 8 shows a method for displaying color images of consecutive frames by using a galvano scanner 150a.

As shown in FIG. 8, during a first scan, with the galvano scanner 150a rotating clockwise and the red light source 112 being solely turned on, only the red light information among the image information of a kth (k is an arbitrary natural number) frame is modulated by the one dimensional optical modulator 130 to be projected onto the screen 170 in the backward direction.

During a second scan, with the galvano scanner 150a rotating counterclockwise and the green light source 114 being solely turned on, only the green color information among the image information of the kth frame is modulated by the one dimensional optical modulator 130 to be projected onto the screen 170 in the forward direction.

During a third scan, with the galvano scanner 150a rotating clockwise and the blue light source 116 being solely turned on, only the blue color light information among the image information of the kth frame is modulated by the one dimensional optical modulator 130 to be projected onto the screen 170 in the backward direction.

During a fourth scan, with the galvano scanner 150a rotating counterclockwise and the weakest light source (the red light source, in this embodiment) being solely turned on, only the red color information among the image information of the kth frame is modulated by the one dimensional optical modulator 130 to be projected onto the screen 170 in the forward direction.

A full color image corresponding to the kth frame is generated through such first to fourth scans, which should be performed within a time less than 1/60 [sec] in the case of NTSC system, and 1/50 [sec] in the case of PAL system.

By repeating the above first through fourth scans, full color images corresponding to (k+1)th, (K+2)th, (K+3)th, . . . , frames can be consecutively generated. These scans also should take less than 1/60 [sec] in the NTSC system, and less than 1/50 [sec] in the PAL system to generate each frame.

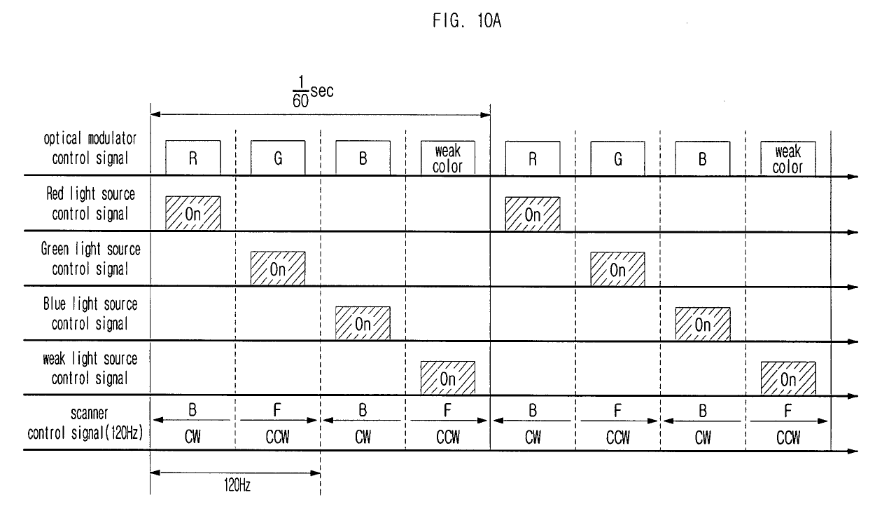

FIG. 9 shows a method for displaying color images of consecutive frames by using a polygon mirror scanner 150b.

Here, the polygon mirror 150b has the shape of a hexagonal prism with mirrors on its sides, but it can also have the shape of another polygonal prism.

Also, the same terms ‘first scan’ through ‘fourth scan’ in the below description regarding FIG. 9 represent that each color is separately scanned sequentially as in the descriptions on FIGS. 7 and 8. However, the polygon mirror scanner 150b of the FIG. 9 rotates in a single-direction (either clockwise or counterclockwise, counterclockwise in the embodiment) unlike the galvano scanner 150a. Accordingly, the scan is performed in a single direction (either backward or forward, forward in this embodiment) in correspondence with the rotational direction.

Furthermore, in FIG. 9, the polygon mirror scanner 150b scans in a horizontal direction, and the modulation is conducted per vertical line by the optical modulator element 130, as an example. However, the polygon mirror scanner 150b can scan in a vertical direction, and the modulation can be conducted per horizontal line.

Referring to FIG. 9, in a first scan, the polygon mirror scanner 150b performs a counterclockwise sixth rotation (an nth rotation, in case that the polygon mirror has the shape of a polygonal prism having n sides), and only the red light source 112 is turned on, so that only red color information among image information of a kth frame (k is an arbitrary natural number) is modulated by the one dimensional optical modulator element 130 to be projected on the screen 170 in the forward direction.

Here, a scanner control signal from the image control circuit 180 controls the polygon mirror scanner 150b to rotate at a certain angular speed in a single direction, or to rotate to a certain position.

In a second scan following the first scan, the polygon mirror scanner 150b performs another counterclockwise sixth rotation, and only the green light source 114 is turned on, so that the only green color information among the image information of the kth frame is modulated by the one dimensional optical modulator 130 to be projected on the screen 170 or other projection surface in the forward direction.

In a third scan following the second scan, the polygon mirror scanner 150b performs another counterclockwise sixth rotation, and only the blue light source 116 is turned on, so that blue color information among the image information of the kth frame is modulated by the one dimensional optical modulator 130 to be projected on the screen 170 in the forward direction.

In a fourth scan following the third scan, the polygon mirror scanner 150b performs another counterclockwise sixth rotation, and only the weakest light source is turned on, so that the light intensity information regarding a color light emitted from the weakest light source is modulated again to be projected on the screen 170 in the forward direction.

Through these first to fourth scans, a full color image corresponding to the kth frame is completed, for which it should take for the polygon mirror scanner 150b to perform the two thirds rotation (four sixths rotation, in other words) less than 1/60 [sec] when using the NTSC system, and less than 1/50 [sec] when using the PAL system. Correspondingly, when the polygon mirror scanner has the shape of a polygonal prism having n sides, four nth rotations should be performed within 1/60 [sec] by the NTSC system, and 1/50 [sec] by the PAL system. Here, one rotation of the polygon mirror scanner 150b refers to a 360°rotation.

By repeating the above first to fourth scans, full color images corresponding to (k+1)th, (k+2)th, (k+3)th, . . . , frames can be generated consecutively. It is obvious that it should take less than 1/60 [sec] by the NTSC system, and less than 1/50 [sec] by the PAL system to generate each frame.

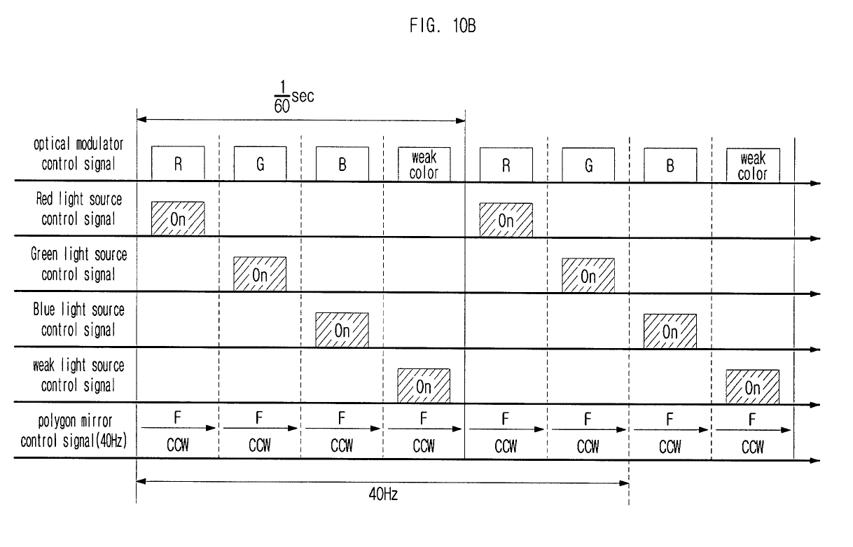

FIGS. 10A and 10B illustrate light source control signals, optical modulator control signals and scanner control signals transferred by the image control circuit 180 with passage of time according to an embodiment of the present invention. The galvano scanner 150a is used in FIG. 10A, and the polygon mirror scanner 150b is used in FIG. 10B. It is assumed that this embodiment is based on the NTSC system, so that the field frequency is 60 Hz, and one frame has a period of 1/60 [sec].

As shown in FIGS. 10A and 10B, the optical modulator control signal having image information, namely, light intensity information, is delivered to the one dimensional optical modulator element 130 in the order of red, green, blue, and the color corresponding to the weakest light source from the image control circuit 180.

Three light source control signals are delivered from the image control signal 180 to the light source unit 110, such that when red color information is delivered, only the red light source 112 is turned on, when green color information is delivered, only the green light source 114 is turned on, and when blue color information is delivered, only the blue light source 116 is turned on. Subsequently, the image control circuit 180 transfers another light source control signal to the light source unit 110, such that the weakest light source is turned on once more.

The galvano scanner 150a used in FIG. 10A projects each color image information onto the screen 170 once, and rotates clockwise to perform a backward scanning, and rotates counterclockwise to perform a forward scanning.

The galvano scanner 150a completes one rotation by conducting a clockwise rotation and a counterclockwise rotation each once. Accordingly, through two rotations, red, green, blue, and the color corresponding to the weakest light source are projected each once, thereby completing a full color image. It takes the galvano scanner 150a 1/120 [sec] to perform one rotation, and therefore the scan frequency is 120 Hz.

The polygon mirror scanner 150b used in FIG. 10B, projects each image information onto the screen 170 once, and rotates either clockwise to perform a backward scanning, or counterclockwise to perform a forward scanning. Here, it is assumed that the polygon mirror scanner 150b has the shape of a hexagonal prism, and thus conducts a total of 6 counterclockwise rotations to perform one rotation. Accordingly, this polygon mirror scanner 150b projects red, green, blue, and the color corresponding to the weakest light source light each once by two third rotations, whereby a full color image is generated. Therefore, it takes the polygon mirror scanner 150b 1/40 [sec] to perform one rotation, and the scan frequency is 40 Hz. In addition, the polygon mirror scanner 150b can be other shapes as well, according to which the scan frequency can varies.

FIGS. 11(a) through 11(c) are tables for comparing the brightness between a 4-time scan and a 3-time scan, in the case that the red light source has the weakest optical power among the three color light sources.

The abbreviated terms used in FIGS. 11(a) through 11(c) will first be explained before describing the tables. ‘Needs’ refers to the amount of optical power ideally needed for realizing the color image information. ‘LD Max’ refers to the maximum amount of optical power outputted by the light source. ‘Effective PW’ refers to the amount of power actually consumed by the light source.

As shown in the tables, the values of ‘Needs’, ‘LD Max’, and ‘Effective PW’ vary according to color. Furthermore, the value of ‘Needs’ varies according to the condition of the display apparatus, and the value of ‘LD Max’ also varies according to the type of the light source, and thus, the value of ‘Effective PW’ varies in correspondence with the values of ‘Needs’ and ‘LD Max’.

The weakest light source refers to the light source, the result of dividing ‘LD Max’ by ‘Needs’ of which is the smallest among the three light sources. For example, in FIG. 11(a), the quotients of ‘LD Max’ to ‘Needs’ of the red, green, and blue light sources are 40/69(0.58), 100/56(1.79), and 50/53(0.94), respectively, so that the red light source is elected as the weakest light source.

Also, ‘RGB’ represents that the red R, green G, and blue B color image information is projected onto the screen each once to generate a color image, ‘RRGB’ represents that the image information on the red color is projected onto the screen once more besides the three time projection of red R, green G, and blue B color image information.

Here, the order of alphabets in ‘RGB’ and ‘RRGB’ does not define the order of scans, and the scans can be performed in any other order.

Referring to FIG. 11(a), the values of ‘Needs’ of the red R, green G, and blue B color light sources are 69 mW, 56 mW, and 53 mW, respectively. Hereinafter, these will be abbreviated as R_{ND}, G_{ND}, and B_{ND}. The values of ‘LD Max’ of them are 40 mW, 100 mW, and 50 mW, respectively. Hereinafter, these will be abbreviated as R_{MAX}, G_{MAX}, and B_{MAX}.

As describe above, the weakest light source refers to the one having the smallest value among the values of R_{MAX}/R_{ND}, G_{MAX}/G_{ND} and B_{MAX} /B_{ND}. In this embodiment, since the values of R_{MAX}/R_{ND}, G_{MAX}/G_{ND} and B_{MAX}/B_{ND} are 0.58, 1.79, and 0.94, respectively, the red light source is elected as the weakest light source.

The ‘RGB’ column of the table in FIG. 11(a) shows the amount of effective optical power actually consumed by each color light source, when the scans are performed three times to generate a color image. Hereinafter, ‘Effective PW’ will be abbreviated as R_{EFF}, G_{EFF}, and B_{EFF} according to color.

Since a total of 3 scans are performed within 1/(the field frequency according to the television broadcasting system) [sec], the light source naturally consumes only a third of its ‘LD Max’. Therefore, ‘Effective PW’ is theoretically a third of ‘LD Max’. In other words, theoretical values of R_{EFF}, G_{EFF}, and B_{EFF} are 13.33(40/3) mW, 33.33(100/3) mW, and 16.67(50/3) mW, respectively.

However, in order to generate a color image free of distortion, the ratio of R_{ND} to G_{ND} to B_{ND} (69:56:53, namely, 1:0.81:0.77) should also be maintained in the ratio of R_{EFF} to G_{EFF} to B_{EFF}. Therefore, the values of R_{EFF}, G_{EFF}, and B_{EFF} are adjusted based on R_{EFF}, which has the smallest value, such that adjusted values of R_{EFF}, G_{EFF}, and B_{EFF} become 13.33 mW, 10.82 mW, and 10.24 mW, respectively.

Here, in the case of the three time scan, the maximum illumination efficiency of the color display apparatus is a third (33.33%) of the maximum optical power of the light source. However, considering that the quotient of the sum of the adjusted optical power to the sum of the maximum optical power is 0.54 (34.39/63.33), the real illumination efficiency lowers to 18.10% (33.33%×0.54).

Next, the ‘RRGB’ column of the table in FIG. 11(a) shows the amount of effective optical power actually consumed by each color light source, when the scans are performed four times to generate a color image by projecting the image information of the weakest light source once again.

Since a total of 4 scans are performed within 1/(the field frequency according to the television broadcasting system) [sec], the light source naturally consumes only a fourth of its ‘LD Max’. Therefore, ‘Effective PW’ is theoretically a fourth of ‘LD Max’.

At this time, because the image information on the color light corresponding to the red R light source is projected twice, the maximum optical power of the red R light source is 80 mW, which is twice as 40 mW. Accordingly, the values of R_{EFF}, G_{EFF}, and B_{EFF} are 20 (80/4) mW, 25 (100/4) mW, and 12.50(50/4) mW, respectively. However, in order to generate a color image free of distortion, the ratio of R_{ND} to G_{ND} to B_{ND} (69:56:53, namely, 1:0.81:0.77) should be maintained in the ratio of R_{EFF} to G_{EFF} to B_{EFF}. Therefore, the values of R_{EFF}, G_{EFF}, and B_{EFF} are adjusted based on B_{EFF}, which has the smallest value, such that adjusted values of R_{EFF}, G_{EFF}, and B_{EFF} become 16.27 mW, 13.21 mW, 12.50 mW, respectively.

Here, in the case of the four time scan, the maximum illumination efficiency of the color display apparatus is a fourth (25%) of the maximum optical power of the light source. However, considering that the quotient of the sum of the adjusted optical power to the sum (41.98) of the maximum optical power (47.5) is 0.88, the real illumination efficiency lowers to 22.10% (25%×0.88).

This result shows that the illumination efficiency of the four time scan type color display apparatus improved by 22.1% (from 18.1% to 22.1%) compared with that of the three time scan type.

In FIG. 11(b), the values of R_{ND}, G_{ND}, and B_{ND} are 79 mW, 56 mW, and 53 mW, respectively, and in FIG. 11(c), the values of R_{ND}, G_{ND}, and B_{ND} are 63 mW, 58 mW, and 54 mW, respectively. Meanwhile, in both FIG. 11(b) and FIG. 11(c), the values of R_{MAX}, G_{MAX}, are B_{MAX} are 40 mW, 100 mW, and 50 mW, respectively. The illumination efficiencies of these two cases can be calculated in the above manner.

FIGS. 11(b) and 11(c) show that the illumination efficiency improved by 33.98% (from 17.42% to 23.34%), and by 12.6% (from 18.93% to 21.32%)) and 12.6% (21.32%/18.93%) compared with the three-time scan type color display apparatus.

The present invention scans the weakest light source twice by using the scanner 150, wherein the light sources can be turned on each once in various orders. However, scanning the same color twice consecutively provides such an advantage that the weakest light source is turned on only once, and the light intensity information corresponding thereto is also extracted only once.

While the invention has been described with reference to the disclosed embodiments, it is to be appreciated that those skilled in the art can change or modify the embodiments without departing from the scope and spirit of the invention or its equivalents as stated below in the claims.

What is claimed is:

1. A color display apparatus comprising:
(a) an N (N is a natural number greater than 2) number of light sources each emitting a different color light in accordance with light source control signals controlling on/off states thereof;
(b) a one dimensional optical modulator element generating diffracted light by modulating the color light emitted from the light sources in accordance with optical modulator control signals;
(c) a scanner scanning and projecting the diffracted light from the one dimensional optical modulator element onto a display surface in accordance with scanner control signals; and
(d) an image control circuit receiving image signals,
and transferring:
the light source control signal, which turns on the N number of light sources each once, and turns on the light source having the weakest optical power thereamong once more,
the optical modulator control signal, which contains light intensity information extracted from the image signal and corresponding to the turned on light source, and
the scanner control signal controlling operation of the scanner which is based on the optical modulator control signal,
to the light source, the one dimensional optical modulator, and the scanner, respectively so as to control the same.

2. The color display apparatus of claim 1, wherein the N number of light sources are composed of red, green, and blue light sources.

3. The color display apparatus of claim 1, wherein the scanner is a rotating galvano scanner performing bidirectional scanning during one rotation of the scanner, and scanning the diffracted light corresponding to one of the N number of light sources per half rotation of the scanner, so that one frame of full color image is projected onto the screen by (N+1)/2 rotations of the galvano scanner.

4. The color display apparatus of claim 3, wherein the galvano scanner rotates (N+1)/2 times within 1/(the field frequency according to a television broadcasting system) [sec].

5. The color display apparatus of claim 1, wherein the scanner is a rotating polygon mirror scanner having the shape of a polygonal prism, and performing single directional scanning, in which the polygon mirror scanner scans the diffracted light corresponding to one of the N number of light sources per 1/(the number of sides of the polygonal prism) rotation of the scanner, so that one frame of full color image is projected onto the screen by (N+1)/(the number sides of polygonal prism) rotations of the polygon mirror scanner.

6. The color display apparatus of claim 5, wherein the polygon mirror scanner rotates (N+1)/(the number of sides of the polygonal prism) times within 1/(the field frequency according to a television broadcasting system) [sec].

7. A recorded medium which tangibly embodies a program having instruction codes on image controlling executable in a color display apparatus comprising light sources, a one dimensional optical modulator, and a scanner, and is readable by the color display apparatus, wherein the image controlling comprises:
(a) turning on one of an N (N is a natural number greater than 2) number of light sources each emitting a different color light;
(b) transferring light intensity information on a color corresponding to the turned on light source to the one dimensional optical modulator element;
(c) controlling the scanner so that diffracted light generated by the one dimensional optical modulator element are scanned and projected onto a display surface; and
(d) repeating the steps (a) through (c) until the light source having the weakest power among the N number of light sources is turned on twice, and the rest of the light sources are turned on each once.

8. The recorded medium containing a program executing image controlling of claim 7, wherein the steps (a) through (c) are performed within 1/{(the field frequency according a television broadcasting system)×(N+1)} [sec].

9. A recorded medium which tangibly embodies a program having instruction codes on image controlling executable in a color display apparatus comprising light sources, a one dimensional optical modulator element, and a scanner, and is readable by the color display apparatus, wherein the image controlling comprises:
(a) turning on one of an N (N is a natural number greater than 2) number of light sources each emitting a different color light;
(b) transferring light intensity information on a color corresponding to the turned on light source to the one dimensional optical modulator element;
(c) controlling the scanner so that diffracted light generated by the one dimensional optical modulator element are scanned and projected onto a display surface; and
(d) repeating the step (c) twice consecutively while the light source having the weakest power among the N number of light sources is turned on, and repeating the steps (a) through (c) until the rest of the light sources are turned on each once.

10. The recorded medium containing a program executing image controlling of claim 9, wherein the steps (a) through (c) are performed within 1/{(the field frequency according to a television broadcasting system)×(N+1)} [sec].
